(19) United States
(12) Patent Application Publication
(10) Pub. No.: US 2013/0002098 A1
(43) Pub. Date: Jan. 3, 2013

(54) Modular Refrigerated Merchandise Display System

(75) Inventor: Emad Jafa, Brewster, NY (US)

(73) Assignee: PEPSICO, INC., Purchase, NY (US)

(21) Appl. No.: 13/292,166

(22) Filed: Nov. 9, 2011

Related U.S. Application Data
(63) Continuation-in-part of application No. 13/173,351, filed on Jun. 30, 2011.

(51) Int. Cl. A47B 87/02; B23P 15/26

(52) U.S. Cl. 312/108; 29/890.035

(57) ABSTRACT

A method of transporting and assembling components of a merchandise display system having one or more display units. The components of the merchandise display system may be shipped to and received at a merchandising location and may lay flat and stack on top of each other during transportation. The components of the merchandise display system may be assembled at the merchandising location. One or more of the components may be pre-assembled and shipped to and received at the merchandising location to be assembled with the remaining components of the merchandising display system. The merchandise display system may include a base unit having a refrigeration unit that cools one or more display units. The refrigeration unit may be removable from the base unit. The display units may be stackable on top of one another and be configured to attach to the base unit.

### CROSS REFERENCE TO RELATED APPLICATIONS

This application is a continuation-in-part application of U.S. application Ser. No. 13/173,351, filed Jun. 30, 2011. This application is incorporated by reference in its entirety.

### FIELD OF THE INVENTION

The invention relates generally to a modular refrigerated display system for storing and dispensing merchandise.

### BACKGROUND

Commercial refrigerators have had the same design and construction for many years. Commercial refrigerators are typically large heavy boxes that have failed to keep up with design trends and consumer expectations. Because of the large size, commercial refrigerators are often under-utilized and only partially filled. The walls of commercial refrigerators are generally formed from two thin steel plates with insulating polyurethane foam injected between them. This construction makes the commercial refrigerators heavy, time-consuming to build, and difficult to recycle. Additionally, many of the commercial refrigerators have negative impacts to the environment because of the type of refrigerant and compressor used.

### SUMMARY OF THE INVENTION

An object of this invention described herein is to provide a light weight modular refrigerated merchandise display system that may be customized depending on the amount of space required. Another object of the invention is to provide visual access of the merchandise within the display system to a customer from one or more angles. Another object of the invention is to provide an easily accessible and replaceable refrigeration unit.

In one aspect of the invention, a merchandise display system includes one or more display units. The one or more display units may include at least one shelf and at least one door for accessing the display unit. The merchandise display system may include a base unit. The base unit may be removable from the merchandise display system. The base unit may also include a cooling system configured to cool the one or more display units and a sensor system configured to sense environmental parameters within the one or more display units. The one or more display units may be attached to the top of the base unit. In at least one embodiment, the merchandise display system includes a plurality of display units attached one on top of each other with the lowermost display unit attached to the top of a base unit.

In another aspect of the invention, a merchandise display system includes one or more display units. In at least one embodiment of the invention, the merchandise display system includes a plurality of display units positioned back to back. In this embodiment, each of the display units includes a plurality of top doors and a plurality of bottom doors. Each display unit may further include a plurality of shelves. The plurality of shelves may be movable within the merchandise display system. Each of the display units may also include a refrigeration unit, which may be removable from the display unit.

In another aspect of the invention, components of a merchandise display system are shipped flat to a merchandising location and assembled at the merchandising location. In at least one embodiment of the invention, one or more components of a merchandise display system, such as doors, side walls, top walls, bottom walls, front walls, shelves, and back walls are stacked on top of each other and adjacent each other and are shipped to a merchandising location in a generally flat configuration. In this embodiment, the components are assembled at a merchandising location to form a modular refrigerated merchandise display system that includes a base unit and one or more display units. The base unit may include a cooling system that is removable from the base unit. In an alternative embodiment, the base unit is pre-assembled and shipped to the merchandising location separately from the components for the one or more display units.

### BRIEF DESCRIPTION OF THE DRAWINGS

FIG. 1 is a perspective view of a merchandise display system in accordance with at least one embodiment of the present invention;

FIG. 2a is a perspective view of a base unit and a display unit in accordance with at least one embodiment of the present invention;

FIG. 2b is a perspective view of a base unit;

FIG. 3 is an alternative embodiment of the merchandise display system of FIG. 1;

FIG. 4 is a perspective view of an alternative embodiment of the merchandise display system in accordance with the present invention;

FIG. 5 is a perspective front view of the merchandise display system of FIG. 4;

FIG. 6a is an exploded perspective view of the shelving system in accordance with at least one embodiment of the present invention;

FIG. 6b is a perspective view of the shelving system of FIG. 6a; and

FIG. 7 is a perspective partial side view of the merchandise display system of FIG. 4.

FIG. 8a is an exploded perspective view of the components of a display unit in accordance with at least one embodiment of the present invention.

FIG. 8b is an exploded perspective view of the components of a base unit in accordance with at least one embodiment of the present invention.

FIG. 9 is a perspective view of the components illustrated in FIGS. 8a and 8b configured to be shipped in accordance with at least one embodiment of the present invention.

FIG. 10 illustrates an example method for shipping and assembling the components of a merchandise display system in accordance with at least one embodiment of the present invention.

### DETAILED DESCRIPTION OF THE INVENTION

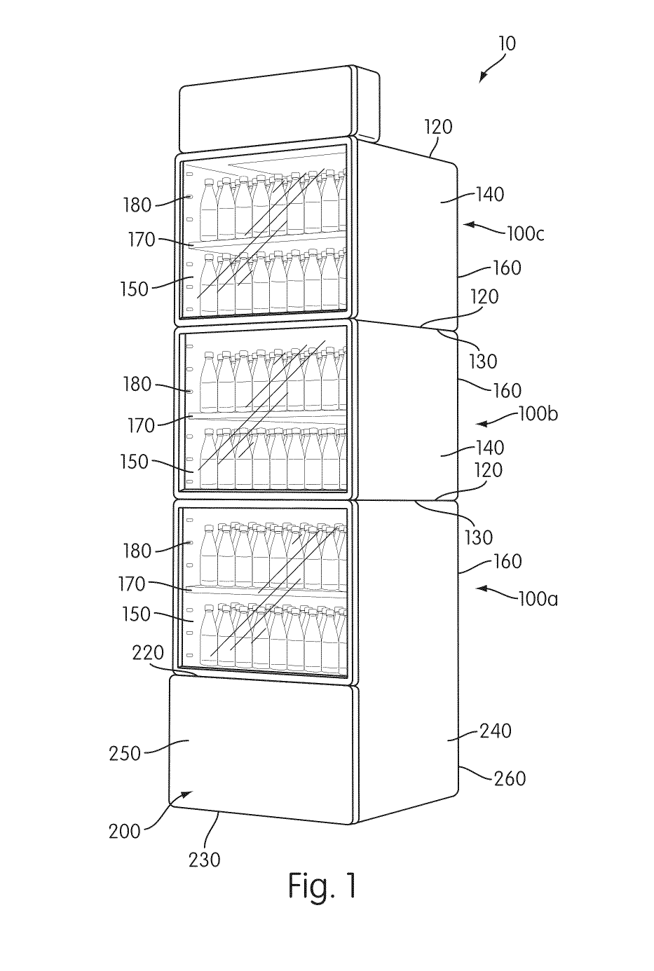

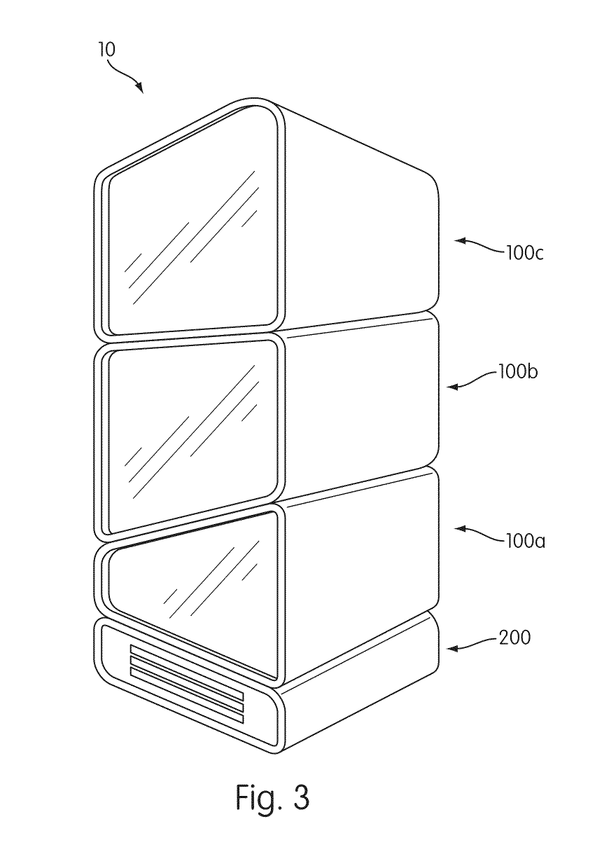

Referring to FIGS. 1 and 3, the merchandise display system according to one embodiment of the present invention is indicated generally at 10. The merchandise display system 10 may be of a modular construction and include a plurality of display units 100 and a base unit 200. The display units 100 and base unit 200 may be made of any suitable material, such as plastic or metal. In one embodiment, the display units 100 are hollow structures filled with a foam-based insulation material, which may reduce the weight of the merchandise display system 10. In one embodiment, the base unit 200 is also a hollow structure filled with a foam-based insulation material, which may reduce the weight of the merchandise display system 10.

The display units 100 and base unit 200 may be any suitable size or shape. In one example, as illustrated in FIG. 1, the display units 100 and base unit 200 are generally cube shaped. Alternatively, as illustrated in FIG. 3, the display units 100 and base unit 200 may be generally trapezoidal. Any suitable shape is contemplated within the scope of this invention, such as a rectangle, circular, or oval shape. The display units 100 and base unit may be the same shape or different shapes.

Referring back to FIG. 1, each of the plurality of display units 100 includes a top wall 120, two side walls 140, a bottom wall 130, a door 150, and a back wall 160. The door 150 may be made of any suitable material, such as glass or plastic. In at least one embodiment, the door 150 is transparent to allow visual access to the product stored and displayed within the display unit 100. The door 150 may open in any suitable manner. For example, in at least one embodiment, one side of the door 150 is hingedly attached to the display unit 100 and the door 150 swings open to allow access to the display unit 100. In at least one embodiment, the door 150 includes a handle for opening the door 150.

Each of the display units 100 may include one or more shelves 170. The shelves 170 may be movable within the display units 100 to accommodate different types or heights of products. Any number of shelves 170 is contemplated within the scope of this invention. The number of shelves 170 may be dependent on the size of the merchandise displayed in the display unit 100, may be dependent on the size of the display unit 100, or a combination of both.

Each display unit 100 may have a lighting system controlled by an electrical module in the base unit 200. In at least one embodiment, the lighting system includes eight light emitting diodes (“LEDs”) 180 installed on the inner surface of each of side walls 140 of the display units 100, as illustrated in FIG. 1. The lighting system may also include exterior lights to attract customers to the merchandise display system 10.

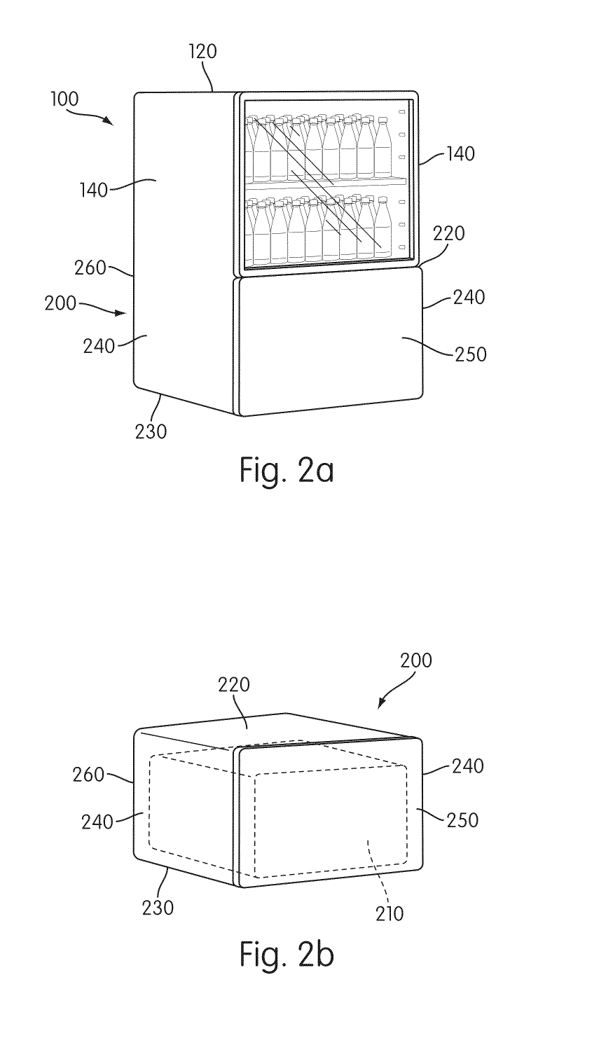

Referring to FIGS. 2a and 2b, the base unit 200 has a top wall 220, a bottom wall 230, two side walls 240, a back wall 260 and a front wall 250. In at least one embodiment, the front wall 250 may be a door. The door may open in any suitable manner. For example, the door may be hinged on one side and swing open to allow access into the base unit 200. In another embodiment, the front wall 250 may be a front portion of a drawer housed within the base unit 200. In this embodiment, the drawer may slide out of the base unit 200. The front wall 250 may be a solid construction or may contain apertures to allow air to flow into and out of the base unit 200.

The base unit 200 may include a cooling system and sensor system. The sensor system may be configured to sense the environment within the display units 100. For example, the sensor system may be configured to detect the temperature or humidity in the interior of the display units 100. In at least one embodiment, the sensor system is in communication with the cooling system in the base unit 200.

As illustrated in FIG. 2b, the cooling system may include a refrigeration unit 210 that is configured to cool the interior of the plurality of display units 100. The refrigeration unit 210 may cool any number of display units 100. For example, the refrigeration unit 210 may cool one display unit 100 or four display units 100. In at least one embodiment, the refrigeration unit 210 is configured to cool three display units 100. In at least one embodiment, the refrigeration unit 210 is removable from the base unit 200. The refrigeration unit 210 may cool each display unit 100 is any suitable way. In one embodiment, a hose is connected from the refrigeration unit 210 to each of the display units 100. In this embodiment, the hose transports air from the base module and sends it to the display units 100.

The refrigeration unit 210 may include typical refrigeration components such as a compressor, a condenser, an evaporator, a fan, etc. The refrigeration unit 210 may use any suitable type of refrigerant to cool the merchandise display system 10. For example, R134A (tetraflouroethane), CO2 (carbon dioxide), or hydrocarbons may be used. The refrigeration components may be placed within the same enclosure in the refrigeration unit 210 and separated as necessary by insulating material. Alternatively, some of the refrigeration components may be placed in separate enclosures within the refrigeration unit 210.

The merchandise display system 10 may utilize any applicable insulation. In one embodiment, the merchandise display system 10 incorporates Aerogel insulation material. Specifically, the merchandise display system may incorporate Spaceloft insulation. The use of Spaceloft insulation may decrease the required thickness of the walls of the display system 10. Insulation may also be used in the refrigeration unit 210 to separate the condenser and evaporator within the same refrigeration unit 210.

In one embodiment, the refrigeration unit 210 may be a hybrid convection-conduction refrigeration system. In this embodiment, the refrigeration unit 210 may include a traditional vapor-compression system, which forces cool air from the refrigeration unit 100 through the display units 100 in the merchandise system 10. The merchandise displayed in the merchandise display system 10 may be cooled through a conduction process where thermal energy is passed from the shelves 170 to the merchandise to cool the merchandise. In this embodiment, heat generated during the cooling process is transferred out of the refrigeration unit 210 and display units 100.

Each display unit 100 may be configured to attach to the base unit 200 or another display unit 100. In this embodiment, each display unit 100 is configured to engage with or attach to the top wall 220 of a base unit 200. Each display unit 100 may also be configured to engage with a top wall 120 of another display unit 100. In at least one embodiment, as depicted in FIGS. 1 and 3, the merchandise display system 10 includes a single base unit 200 and three display units 100a-c. In this embodiment, the base unit 200 is located at the bottom. A first display unit 100a is attached to the top wall 220 of the base unit 200. A second display unit 100b is attached to the top wall 120 of the first display unit 100a and a third display unit 100c is attached to the top wall 120 of the second display unit 100b. In one embodiment, as illustrated in FIG. 2a, the base unit 200 may be of unitary construction with one of the display units 100.

The display units 100 may be attached to the base unit 200 and other display units 100 in any suitable manner. In at least one embodiment, the display units 100 and the base unit 200 are attached together through the use of corresponding rails. In this embodiment, the base unit 200 may include one or more rails on the top wall 220 of the base unit 200, which engages with one or more corresponding rails on the bottom wall 130 of a base unit 100. The display units 100 may attach to each other in a similar manner. For example, each of the display units 100 may include one or more rails on each of the top walls 120, which may attach to one or more corresponding rails on the bottom walls 130 of another display unit 100. In this embodiment, the rails keep the display units 100 and base unit 200 aligned to give the appearance of a single refrigerator. However, display units 100 may be added or removed depending on the amount of space required.

The merchandise display system 10 may include logos or signs to further promote the brand or type of merchandise within the merchandise display system 10. The logos and signs may be place on any suitable surface of the merchandise display system 10. For example, a sign may be placed on the top wall 120 of the top display unit 100 or logos may be attached to the doors 150 or side walls 140 of the display units 100.

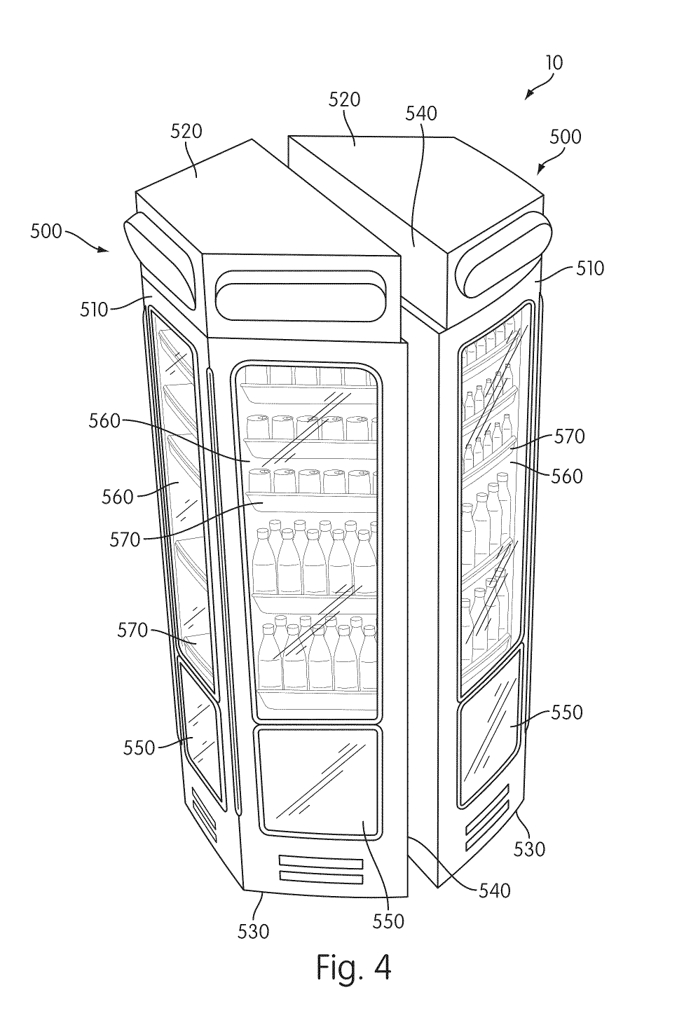

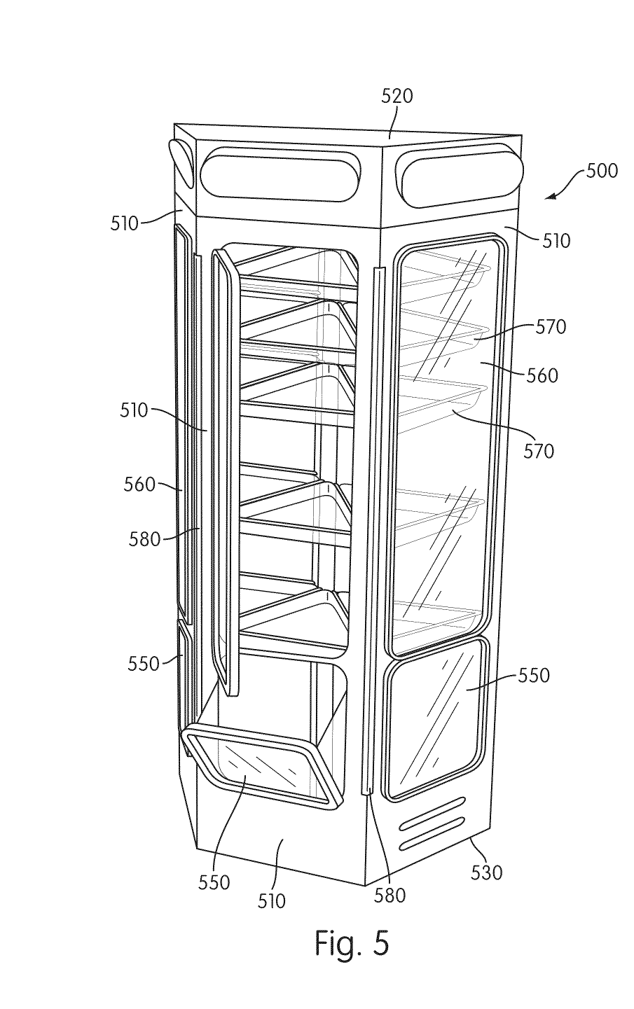

In another aspect of the invention, as illustrated in FIG. 4, a plurality of display units 500 combine together to form a 360 degree merchandise display system 10. The merchandise display system 10 may include any number of display units 500. In at least one embodiment, the display system 10 includes two display units 500, positioned back to back. The display units 500 may be made of any suitable material, such as metal or plastic. In one embodiment, the display units 500 are hollow structures filled with a foam-based insulation material, which may reduce the weight of the merchandise display system 10.

The display units 500 may include a top wall 520, a bottom wall 530, a back wall 540, and a front wall 510. The front wall 510 may include a plurality of upper doors 560 and a plurality of lower doors 550. The display units 500 may contain any suitable number of upper doors 560 and lower doors 550. In at least one embodiment, each of the display units includes at least three upper doors 560 and three lower doors 550. The upper doors 560 and lower doors 550 may be made of any suitable material such as glass or plastic. In at least one embodiment, the upper doors 560 and lower doors 550 are transparent to allow visual access of the merchandise within the display unit 500. The display units 500 may be any suitable shape and size. For example, the display units may be square, rectangular, circular, semi-circular, or polygonal.

The upper doors 560 and lower doors 550 may open in any suitable manner. For example, one side of the upper doors 560 may be hingedly attached to the front wall 510 and swing outwardly to allow access to the display unit 500. In at least one embodiment, the bottom edge of the lower doors 550 is hingedly attached to the display unit 500 to allow the bottom door 550 to open outwardly from the top edge of the door 550. In at least one embodiment, the upper doors 560 and the lower doors 550 include a handle to aid in opening the upper doors 560 and lower doors 550.

The merchandise display system 10 may include a plurality of shelves 570. The plurality of shelves 570 may be made of any suitable material, such as plastic or metal. In at least one embodiment, the plurality of shelves 570 are wire structures. In at least one embodiment, the plurality of shelves 570 may be tilted or angled. The plurality of shelves 570 may be angled such that the front of the shelves 570 is lower than the back of the shelves 570. In this embodiment, gravity forces the merchandise displayed on the plurality of shelves 570 forward towards the front of the shelves 570. Alternatively, the plurality of shelves 570 may be in a horizontal position within the merchandise display system 10. The plurality of shelves may be any suitable shape. For example, the plurality of shelves 570 may be a triangular or rectangular shape.

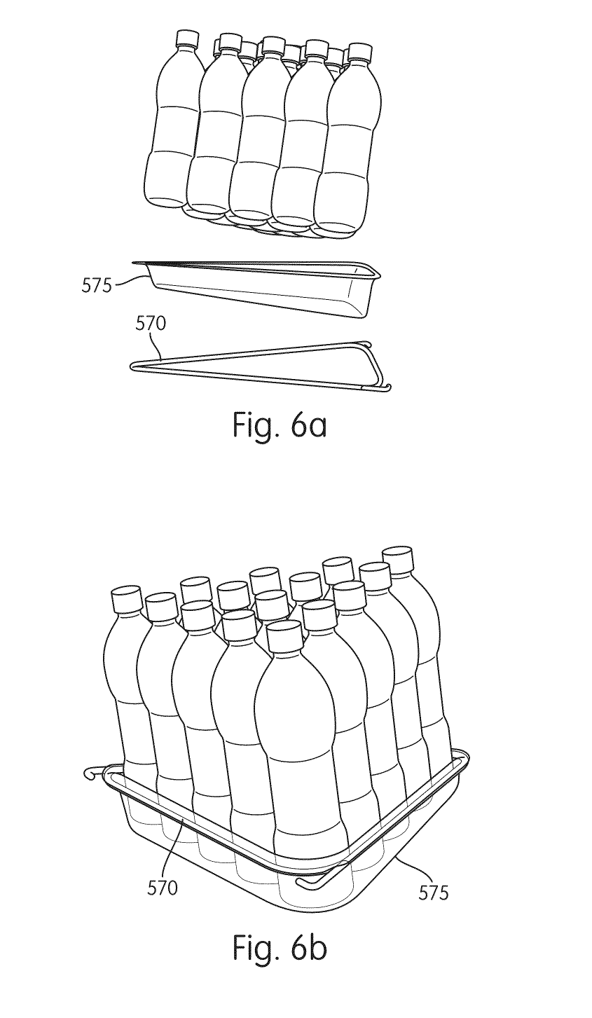

As illustrated in FIGS. 6a and 6b, the plurality of shelves 570 may further include a basket 575 for the merchandise to be placed in. The basket 575 may rest on top of the plurality of shelves 570 or the shelves 570 may form a frame around the basket 575 and support the basket 575. In one embodiment, the plurality of shelves 570 are triangular frames that support a triangular plastic basket within the frame. In at least one embodiment, the plurality of shelves 570 are movable to different heights within the display unit 500 to accommodate merchandise of different heights. In at least one embodiment, the baskets 575 and the shelves 570 are removable from the merchandise display system 10. Any number of shelves 570 are contemplated within the scope of this invention. The number of shelves 570 may depend on many factors, such as the size of the display unit 500 and the size of the product being merchandised.

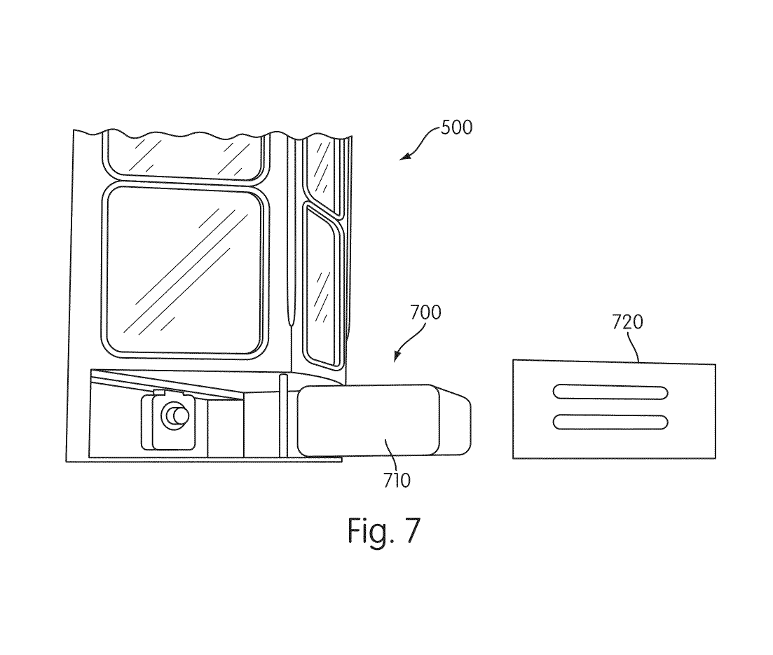

As illustrated in FIG. 7, the merchandise display system 10 may include a base unit 700. In one embodiment, the base unit 700 is removable from the merchandise display system 10. In an alternative embodiment, the base unit 700 is attached to or integral to the merchandise display system 10. The base unit 700 includes a refrigeration unit 710 and a housing 720. The housing 720 may be made of any suitable material and may be of solid construction or may include a plurality of apertures to allow air to flow into and out of the base unit 700.

In at least one embodiment, the refrigeration unit 710 may be removable from the base unit 700. The removable refrigeration unit 710 allows for easy installation and maintenance of the refrigeration unit 710. For example, a technician may chose to replace the removable refrigeration unit 710 rather than repair it while it is connected to the merchandise display system 10.

The refrigeration unit 710 may include typical refrigeration components such as a compressor, a condenser, an evaporator, a fan, etc. The refrigeration unit 710 may use any suitable type of refrigerant to cool the merchandise display system 10. For example, R134A (tetraflouroethane), CO2 (carbon dioxide), or hydrocarbons may be used. The refrigeration components may be placed within the same enclosure in the refrigeration unit 710 and separated as necessary by insulating material. Alternatively, some of the refrigeration components may be placed in separate enclosures within the refrigeration unit 710.

The merchandise display system 10 may utilize any applicable insulation. In one embodiment, the merchandise display system 10 incorporates Aerogel insulation material. Specifically, the merchandise display system may incorporate Spaceloft insulation. The use of Spaceloft insulation may decrease the required thickness of the walls of the display system 10. Insulation may also be used in the refrigeration unit 710 to separate the condenser and evaporator within the same refrigeration unit 710.

In one embodiment, the refrigeration unit 710 may be a hybrid convection-conduction refrigeration system. In this embodiment, the refrigeration unit 710 may include a traditional vapor-compression system, which forces cool air from the refrigeration unit 710 through the display units 500 in the merchandise system 10. The merchandise displayed in the merchandise display system 10 may be cooled through a conduction process where thermal energy is passed from the shelves 570 to the merchandise to cool the merchandise. In this embodiment, heat generated during the cooling process is transferred out of the refrigeration unit 710 and display units 500.

The merchandise display system may further include a lighting system. The lighting system may include interior and exterior lighting. In at least one embodiment, the display units 500 include a plurality of exterior lights 580. The exterior lights 580 may be any suitable type of lighting, such as LEDs. The exterior lights 580 may extend vertically on the front wall 510 of the display unit 500. The exterior lights 580 may extend from the top wall 520 to the bottom wall 530 or may extend along only a portion of the front wall 510.

The display units 500 may further include a sensor system. The sensor system may be configured to sense the environment within the display unit 500. For example, the sensor system may be configured to detect the temperature or humidity in the interior of the display units 500. In at least one embodiment, the sensor system is in communication with the cooling system in the base unit 700.

The merchandise display system 10 may include logos or signs to further promote the brand or type of merchandise within the merchandise display system 10. The logos and signs may be place on any suitable surface of the merchandise display system 10. For example, a sign may be placed on the top wall 520 of the display unit 500 or logos may be attached to the upper doors 560 and lower doors 550.

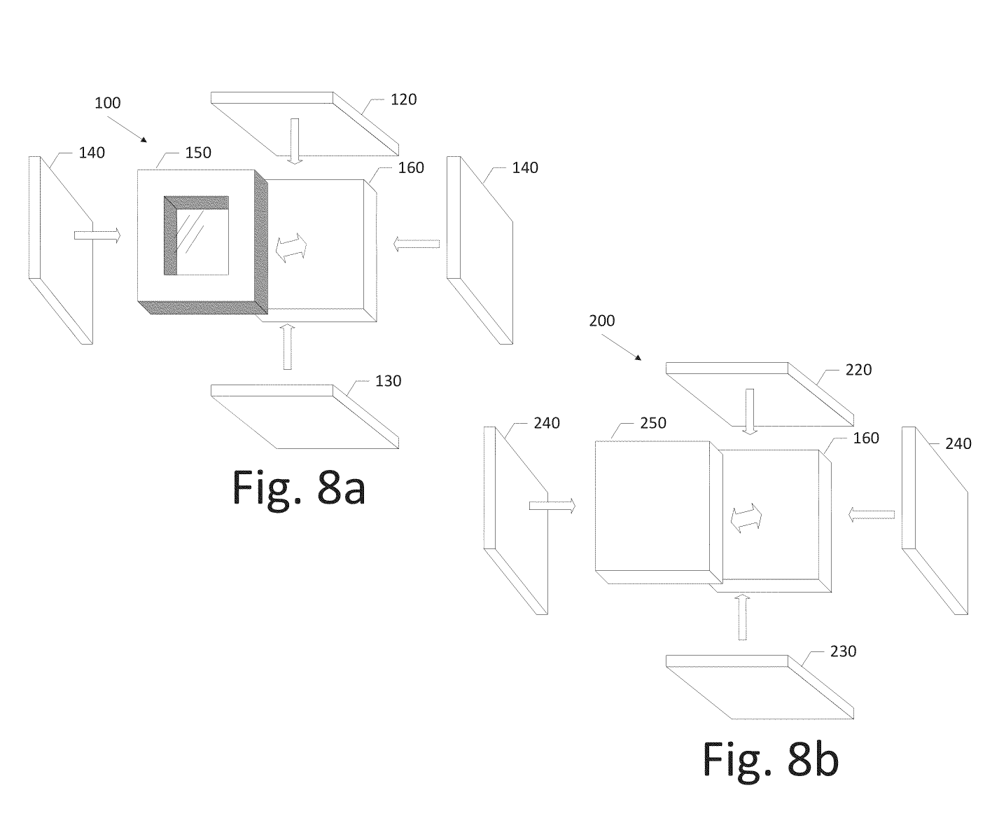

In accordance with at least one of the embodiments described above, all or portions of the merchandise display system 10 may be shipped as component pieces and assembled at a merchandising location, such as a retail store. As illustrated in FIGS. 8a and 8b, each of the components of a display unit 100 and a base unit 200 may be separate from each other and attached together to form one or more display units 100 or base units 200. For example, as illustrated in FIG. 8a, two side walls 140 may attach to a top wall 120. A back wall 160 may attach to the two side walls 140 and the top wall 120. A bottom wall 130 may attach to the two side walls 140 and the back wall 160. A door 150 may attach to one or more of the bottom wall 130, two side walls 140, and the top wall 120 to form a display unit 100. In at least one embodiment, the display unit 100 includes a plurality of shelves 170 that are attached to at least the two side walls 140 and are configured to display product within the display unit 100.

The components of a base unit 200 may be assembled in a similar manner as the components for the display unit 100. As illustrated in FIG. 8b, two side walls 240 may attach to a top wall 220. A back wall 260 may attach to the two side walls 240 and the top wall 220. A bottom wall 230 may attach to the two side walls 240 and the back wall 260. A front wall 250 may attach to one or more of the bottom wall 230, two side walls 240, and the top wall 220 to form a base unit 200. The base unit may further include a cooling system that is removable from the base unit 200. The cooling system may include a refrigeration unit 210 and a sensor system.

The components of the display units 100 and the base units 200 may be assembled in any order and may be attached to each other in any suitable manner. For example, the one or more of the components may include tabs that cooperate with corresponding apertures on another component to attach two or more components together. The components may include projections that cooperate with a corresponding aperture on another component to attach two or more components together. Other types of attachment mechanisms, such as cam locks, locking latches, and locking brackets may be used to lock two or more components to each other.

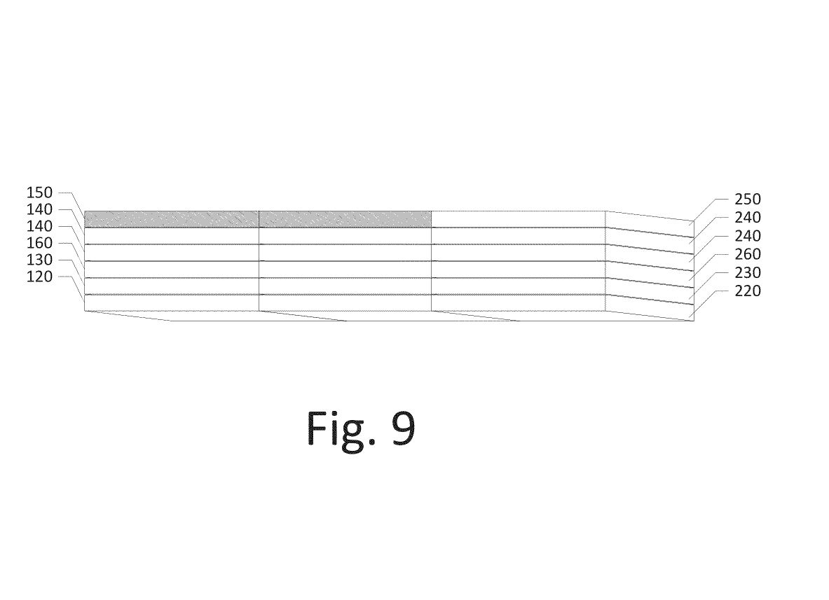

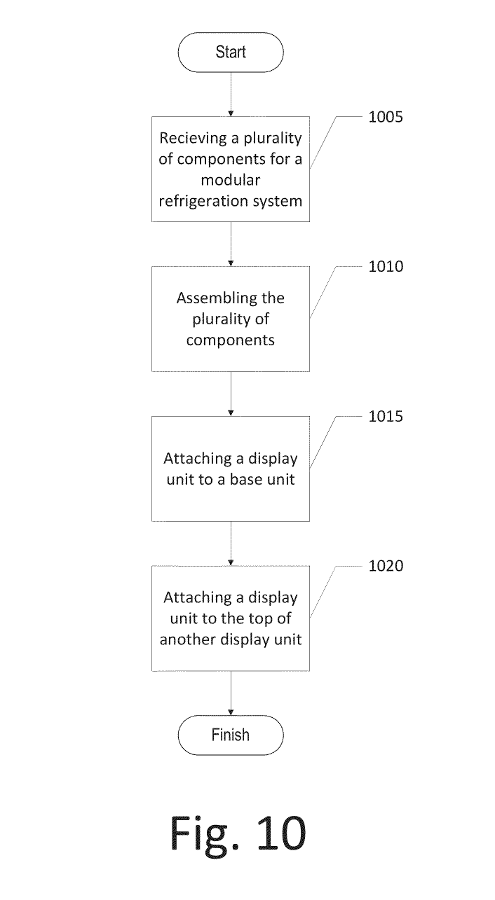

In at least one embodiment, some or all of the components of a merchandise display system 10 may be shipped flat to the merchandising location. As illustrated in FIG. 9, the components of one or more base units 200 and one or more display units 100 may be stacked on top of each other or positioned next to each other and shipped in a generally flat configuration. For example, the side walls 140, door 150, top wall 120, bottom wall 130 and back wall 160 of a display unit 100 may be stacked one on top of each other and positioned in a box next to the side walls 240, front wall 250, top wall 220, bottom wall 230 and back wall 260 of a base unit 200, which may also be stacked on each other. Any number of components may be shipped flat to the merchandising location.

FIG. 9 illustrates an example method of assembling a merchandise display system 10 incorporating one or more features described above. In step 1005, one or more of the components of a merchandise display system 10 are shipped in a generally flat configuration to a merchandising location, such as a retail store, and received at the merchandising location. The components may include one or more of the following: top walls 120, 220; bottom walls 130, 230; side walls 140, 240; back walls 160, 260; doors 150, front walls 250, and a plurality of shelves 170. A cooling system, including a refrigeration unit 210 and sensor system may be shipped and received with the components or may be pre-assembled and shipped or received separately from the components. In one embodiment, the base unit 200 is pre-assembled and shipped and received separately from the components of the display units 100.

In step 1010, one or more of the components are assembled together at the merchandising location. For example, a top wall 120, bottom wall 130, two side walls 140, a back wall 160 and a door 150 are attached together to form a display unit 100. The display unit 100 may include one or more shelves 170. In step 1010, the components of a base unit 200 may also be assembled together. For example, a top wall 220, bottom wall 230, two side walls 240, a back wall 260, and a front wall 250 may be attached to form a base unit 200. The base unit may further include a cooling system that is removable from the base unit 200. The cooling system may include a refrigeration unit 210 and a sensor system. One or more display unit 100 and base unit 200 may be assembled in step 1010.

In step 1015, a first display unit 100 is attached to a top surface of a base unit 200. The first display unit 100 may be attached to the base unit 200 in any suitable manner. For example, as discussed above, the first display unit 100 and the base unit 200 are attached together through the use of corresponding rails. The base unit 200 may include one or more rails on the top wall 220 of the base unit 200, which engage with one or more corresponding rails on the bottom wall 130 of the first base unit 100.

In step 1020, a second display unit 100 may be attached a top surface of the top wall 120 of the first display unit 100. The display units 100 may attach to each other in a similar manner as the first display unit 100 and base unit 200. For example, each of the display units 100 may include one or more rails on each of the top walls 120, which may attach to one or more corresponding rails on the bottom walls 130 of another display unit 100. The rails may keep the display units 100 and base unit 200 aligned to give the appearance of a single modular refrigerator system. Any number of display units 100 may be attached to each other in step 1020.

As discussed above, the merchandise display system 10 may be any size. For example, the merchandise display system 10 may be a suitable size to display on a countertop or may be the size of a commercial refrigerator. The merchandise display system 10 may include one or more doors 150 that cover the front of the display units 100. The merchandise display system 10 may include one door 150 for each of the display units 100. Alternatively, one door 150 may extend vertically or horizontally to cover more than one display unit 100. In at least one embodiment, a single door 150 covers a plurality of display units 100 that are stacked on top of each other. In an alternative embodiment, a single door covers a plurality of display units 100 that are positioned adjacent each other.

While the invention has been described with respect to certain preferred embodiments, as will be appreciated by those skilled in the art, it is to be understood that the invention is capable of numerous changes, modifications and rearrangements and such changes, modifications and rearrangements are intended to be covered by the following claims. Additionally, one of ordinary skill in the art will appreciate that the steps illustrated in the illustrative figures may be performed in other than the recited order, and that one or more steps illustrated may be optional in accordance with aspects of the disclosure.

What is claimed is:

1. A method comprising:
receiving a plurality of components for a modular refrigeration system at a merchandising location, wherein the plurality of components for the modular refrigeration system are received in a generally flat configuration; and
assembling, at the merchandising location, the plurality of components into a modular refrigeration system having at least one display unit and a base unit,
wherein the plurality of components for the modular refrigeration system include one or more of the following:
top walls;
bottom walls;
side walls;
back walls;
doors;
front walls; and
shelves.

2. The method of claim 1, wherein the base unit includes a cooling system that is pre-assembled at a location remote from the merchandising location.

3. The method of claim 2, wherein the cooling system is received separately from the plurality of components for the modular refrigeration system.

4. The method of claim 1, wherein the modular refrigeration system includes at least one display unit each having a top wall, a bottom wall, two side walls, a back wall, a door, and at least one shelf.

5. The method of claim 1, wherein the base unit includes a top wall, a bottom wall, two side walls, a back wall, and a front wall.

6. The method of claim 2, wherein the cooling system includes a refrigeration unit and a sensor system.

7. The method of claim 2, wherein the cooling system is removable from the modular refrigeration system.

8. The method of claim 1, wherein the modular refrigeration system includes a plurality of display units including a first display unit and a second display unit.

9. The method of claim 8, further comprising:
attaching the first display unit to a top surface of the base unit.

10. The method of claim 9, further comprising:
attaching the second display unit to a top surface of the first display unit.

11. An apparatus comprising:
a plurality of components for a modular refrigeration system configured to be assembled at a merchandising location into at least one display unit and at least one base unit,
wherein the plurality of components are configured to stack on top of one another and be positioned in a generally flat configuration when unassembled,
wherein the at least one display unit is configured to attach to a top surface of the at least one base unit, and
wherein the plurality of components for the modular refrigeration system include one or more of the following:
top walls;
bottom walls;
side walls;
back walls;
doors;
front walls; and
shelves.

12. The apparatus of claim 11, wherein the at least one display unit is formed by assembling a top wall, a bottom wall, two side walls, a back wall, and a door.

13. The apparatus of claim 11, wherein the at least one base unit is formed by assembling a top wall, a bottom wall, two side walls, a back wall, and a front wall.

14. The apparatus of claim 11, wherein the at least one base unit includes a removable cooling system.

15. The apparatus of claim 12, wherein the at least one display unit includes at least one shelf within the interior of the at least one display unit.

16. The apparatus of claim 11, wherein a bottom surface of the at least one display unit includes one or more rails configured to engage with one or more corresponding rails on the top surface of the base unit.

17. A method comprising:
receiving a plurality of components for a modular refrigeration system to a merchandising location, wherein the plurality of components for the modular refrigeration system is receiving in a generally flat configuration;
assembling, at the merchandising location, the plurality of components into a plurality of display units including a first display unit and a second display unit;
attaching, at the merchandising location, the first display unit to a top surface of a base unit; and
attaching, at the merchandising location, the second display unit to a top surface of the first display unit,
wherein the plurality of components for the plurality of display units include one or more of the following:
top walls;
bottom walls;
side walls;
back walls;
doors; and
shelves.

18. The method of claim 17, wherein at least a portion of the components of the base unit are received with the components for the modular refrigeration system.

19. The method of claim 17, wherein the base unit is pre-assembled and received separately from the components for the plurality of display units.

20. The method of claim 17, wherein the base unit includes a cooling system that is removable from the modular refrigeration system.
